(19) United States
(12) Patent Application Publication
(10) Pub. No.: US 2008/0267055 A1
(43) Pub. Date: Oct. 30, 2008

(54) METHODS AND APPARATUS TO CANCEL NOISE USING A COMMON REFERENCE WIRE-PAIR

(76) Inventor: Thomas Starr, Barrington, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/739,957

(22) Filed: Apr. 25, 2007

(51) Int. Cl. H04J 3/10

(52) U.S. Cl. 370/201

(57) ABSTRACT

Methods and apparatus to cancel noise using a common reference wire-pair are disclosed. An example method comprises measuring a first signal present on a first wire-pair at a noise canceller, the first wire-pair to be connected to the first noise canceller and to be connected to a customer-premises digital subscriber line (DSL) modem, wherein the noise canceller and the customer-premises DSL modem are to be disposed at different customer-premises locations, and cancelling a first noise received on a second wire-pair at the noise canceller based on the first signal.

### FIELD OF THE DISCLOSURE

This disclosure relates generally to communications networks and/or systems and, more particularly, to methods and apparatus to cancel noise using a common reference wire-pair in communication networks and/or systems.

### BACKGROUND

Communication systems (e.g., implemented using digital subscriber line (DSL) technologies) are commonly utilized to provide Internet related services to subscribers, such as, for example, homes and/or businesses (also referred to herein as users, customers and/or customer-premises). DSL technologies enable customers to utilize telephone lines (e.g., ordinary twisted-pair copper telephone lines used to provide Plain Old Telephone System (POTS) services) to connect the customer to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) at a central office, remote terminal, and/or a serving terminal to provide DSL communication services to a plurality of modems located at respective customer-premises. In general, a central office DSL modem receives broadband service content from, for example, a backbone server and forms a digital downstream DSL signal to be transmitted to a customer-premises DSL modem. Likewise, the central office DSL modem receives an upstream DSL signal from the customer-premises DSL modem and provides the data transported in the upstream DSL signal to the backbone server.

In many instances, two or more DSL modems at different, but often nearby, customer-premises utilize respective twisted-pair copper telephone lines that are bundled together (e.g., contained within) in a distribution cable. Because the telephone lines are bundled together, the two or more DSL modems may experience related and/or substantially similar environmental noise (e.g., radio frequency (RF) interference) and/or crosstalk noise (e.g., from other DSL modems sharing the same distribution cable).

### BRIEF DESCRIPTION OF THE DRAWINGS

FIG. 1 is a schematic illustration of an example digital subscriber line (DSL) communication system constructed in accordance with the teachings of the invention.

FIG. 2 is an example manner of implementing a receiver for any or all of the example DSL modems of FIG. 1, and/or any or all of the example noise cancellers of FIG. 1.

FIGS. 3 and 4 illustrate example manners of implementing the example noise processor of FIG. 2.

FIG. 5 illustrates an example manner of implementing any or all of the example controllers of FIGS. 3 and 4.

FIG. 6 is a flowchart representative of example machine accessible instructions which may be executed to implement any or all of the example noise cancellers of FIGS. 1 and/or 2.

FIG. 7 is a schematic illustration of an example processor platform that may be used and/or programmed to execute the example machine accessible instructions of FIG. 6 to implement any or all of the example noise cancellers and/or, more generally, any or all of the example DSL modems described herein.

### DETAILED DESCRIPTION

Methods and apparatus to cancel noise using a common reference wire-pair are disclosed. A disclosed example method includes measuring a first signal present on a first wire-pair at a noise canceller, the first wire-pair to be connected to the first noise canceller and to be connected to a customer-premises digital subscriber line (DSL) modem, wherein the noise canceller and the customer-premises DSL modem are to be disposed at different customer-premises locations, and cancelling a first noise received on a second wire-pair at the noise canceller based on the first signal.

A disclosed example noise canceller to cancel a first noise received on a first wire-pair based on a first signal received on a second wire-pair, the second wire-pair to be in communication with a first customer-premises DSL modem, and to be in communication with a second customer-premises DSL modem, the first customer-premises DSL modem to be disposed at a first customer-premises location, and the second customer-premises DSL modem to be disposed at a second customer-premises location, the noise canceller includes a filter to apply a filter coefficient to the first signal, and a subtractor to subtract an output of the filter from the first noise. Another disclosed example noise canceller includes an analog module to receive a first signal on a first wire-pair, the first wire-pair in communication with a first customer-premises DSL modem and in communication with a second DSL modem, the first customer-premises DSL to be disposed at a first a customer-premises location and the second DSL modem to be disposed at a second customer-premises location, and a noise processor to cancel a first noise received on a second wire-pair based on the first signal to form an enhanced DSL signal.

A disclosed example DSL communication system includes a first customer-premises DSL modem to be disposed at a first location, a second customer-premises DSL modem to be disposed at a second location, a DSL access multiplexer to provide a first DSL service to the first customer-premises DSL modem via a first wire-pair of a distribution cable, and to provide a second DSL service to the second customer-premises DSL modem via a second wire-pair of the distribution cable. The example DSL communication system further includes a third wire-pair of the distribution cable to be connected to the first and the second customer-premises DSL modems, and a noise canceller to cancel a first noise received on the first wire-pair based on a signal received on the third wire-pair. A disclosed example apparatus includes a DSL access multiplexer to provide a first DSL service to a first customer-premises DSL modem via a first wire-pair of a distribution cable, and to provide a second DSL service to a second customer-premises DSL modem via a second wire-pair of the distribution cable, the first customer-premises DSL modem to be disposed at a first location, and the second customer-premises DSL to be disposed at a second location. The disclosed example apparatus further includes a noise canceller to cancel a first noise received on the first wire-pair based on a signal received on a third wire-pair of the distribution cable, the third wire-pair to be connected to the first and second customer-premises DSL modem.

In the interest of brevity and clarity, throughout the following disclosure references will be made to connecting a digital subscriber line (DSL) modem and/or a DSL communication service to a customer. However, it will be readily apparent to persons of ordinary skill in the art that connecting a DSL modem to a customer involves, for example, connecting a first DSL modem operated by a communications company (e.g., a central office (CO) DSL modem implemented by a DSL access multiplexer (DSLAM)) to a second DSL modem located at, for example, a customer-premises (e.g., a home, an apartment, a town home, a condominium, a hotel room, a motel room and/or place of business owned, leased and/or operated by a customer) via a twisted-pair telephone line (i.e., a wire-pair). The customer-premises (e.g., the second) DSL modem may be further connected to other communication and/or computing devices (e.g., a personal computer, a set-top box, etc.) that the customer uses and/or operates to access a service (e.g., Internet access, Internet protocol (IP) Television (TV), etc.) via the CO DSL modem, the customer-premises DSL modem, the wire-pair and the communications company.

Further, throughout the following description a single common reference wire-pair (i.e., a sensing wire-pair) is used to cancel noise present on another wire-pair that is actively carrying DSL signals and/or DSL communication services. However, persons of ordinary skill in the art will readily appreciate that the methods and apparatus may also be used to cancel noise using more than one (e.g., two) sensing wire-pairs and/or wires. Further still, while the example methods and apparatus are described herein with reference to cancelling noise at customer-premises DSL modems, persons of ordinary skill in the art will readily appreciate that the example methods and apparatus may also be used to cancel noise using one or more sensing wire-pairs at a central office DSL modem (e.g., at a DSLAM located in a central office, a serving area interface, a remote terminal, and/or a serving terminal). Moreover, while methods and apparatus to cancel noise for DSL communication systems using a common reference wire-pair are described herein, persons of ordinary skill in the art will readily appreciate that the example methods and apparatus may also be used to cancel noise using a common wire and/or wire-pair for other types of communication systems such as, but not limited to, public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or any combination and/or hybrid of these devices, systems and/or networks.

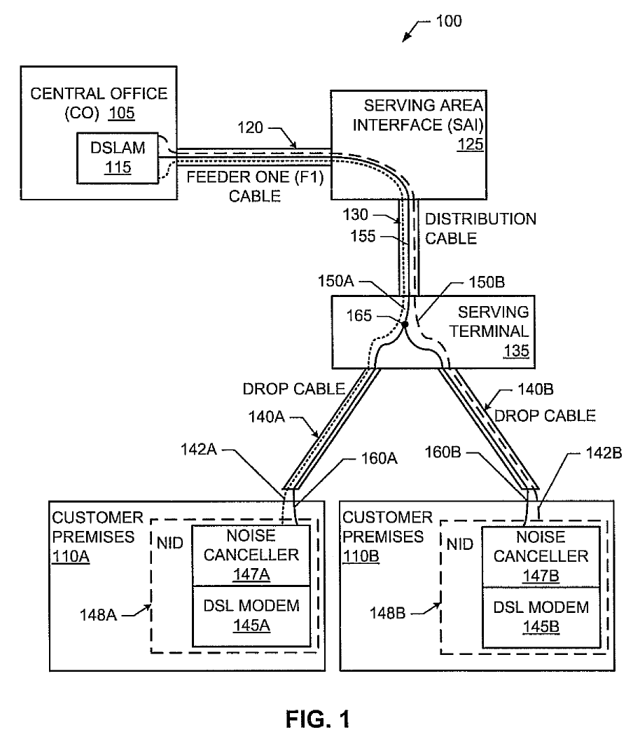

FIG. 1 illustrates an example DSL communication system in which a central office (CO) 105, remote terminal, and/or serving terminal 135 provides data and/or communication services (e.g., telephone services, Internet services, data services, messaging services, instant messaging services, electronic mail (email) services, chat services, video services, audio services, gaming services, etc.) to one or more customer-premises, two of which are designated at reference numerals 110A and 110B. The example customer-premises 110A and 110B of FIG. 1 are at different, but possibly nearby, geographic locations (e.g., different residential homes, different apartments, different condominiums, different hotel and/or motel rooms, and/or different businesses). Moreover, even though two customer-premises 110A and 110B may be, for example, located within the same building (e.g., apartments), they will be considered herein as different customer-premises locations. To provide DSL communication services to the customer-premises 110A and 110B, the example CO 105 of FIG. 1 includes any number and/or type(s) of DSLAMs, one of which is designated at reference numeral 115. The example DSLAM 115 of FIG. 1 includes one or more CO DSL modems (not shown) implemented, for example, in accordance with the ITU-T G.992.x family of standards and/or the ITU-T G.993.x family of standards, for respective ones of the customer-premises 110A and 110B.

In the illustrated example of FIG. 1, the DSLAM 115 provides the DSL services to the customer-premises 110A and 110B via respective wire-pairs of a Feeder One (F1) cable 120. The example F1 cable 120 of FIG. 1 connects the DSLAM 115 to a Serving Area Interface (SAI) 125. At the example SAI 125 of FIG. 1, respective wire-pairs of the F1 cable 120 are connected to respective wire-pairs of one or more distribution cables, one of which is designated in FIG. 1 with reference numeral 130. Wire-pairs of the example distribution cable 130 of FIG. 1 are connected at their other ends (i.e., at a serving terminal 135) to respective wire-pairs of one or more drop cables, two of which are designated in FIG. 1 with reference numerals 140A and 140B. At the example customer-premises 110A and 110B, active wire-pairs 142A and 142B of the drop cables 140A and 140B are connected to respective DSL modems 145A and 145B. Thus, as illustrated in FIG. 1, the DSLAM 115 is connected via a sequence 150A of one or more electrically coupled wire-pairs (e.g., having different gauges and/or being spliced at the SAI 125 and/or the serving terminal 135) to the DSL modem 145A, and via a second sequence 150B of one or more electrically coupled wire-pairs (e.g., having different gauges and/or being spliced at the SAI 125 and/or the serving terminal 135) to the DSL modem 145B. However, for ease of discussion and as commonly used in the DSL industry, the example entire communication paths 150A and 150B respectively coupling the DSLAM 115 to the DSL modems 145A and 145B will be referred to herein as the active wire-pairs 142A and 142B, even though the communication paths 150A and 150B include more wire-pair segments than those contained in the drop cables 140A and 140B. Further, the wire-pairs 142A and 142B are referred to herein as active wire-pairs 142A and 142B because they carry active and/or live DSL signals used to provide DSL communication services. Persons of ordinary skill in the art will readily appreciate that the example DSLAM 115 of FIG. 1 may be implemented and/or located at the SAI 125, a remote terminal, and/or the serving terminal 135.

To cancel noise present on and/or coupled into their respective active wire-pairs 142A and 142B, the DSL modems are 145A and 145B and connected to their respective active wire-pairs 142A and 142B via a respective noise canceller 147A and 147B. One or more of the example noise canceller 147A and 147B of FIG. 1 may be implemented separately from its respective DSL modem 145A, 145B. Additionally or alternatively, a DSL modem 145A, 145B may implement and/or include any or all of its respective noise canceller 147A, 147B.

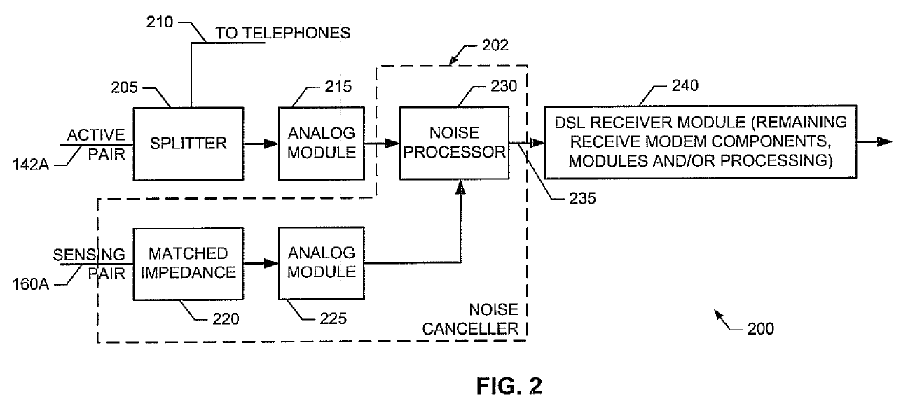

In some examples, to reduce and/or eliminate the effects of wiring within the customer-premises 110A and/or 110B, the example DSL modems 145A and 145B are located and/or implemented at and/or within a respective network interface device (NID) 148A and 148B. Often NIDs 148A and 148B are located on the outside of an exterior wall of the customer-premises 110A and 110B, and serve as the demarcation points between equipment and/or cables (e.g., the drop cables 140A and 140B) owned, leased and/or operated by a service provider, and equipment and/or wiring owned, leased and/or operated by a customer (e.g., a computer communicatively coupled to the DSL modem 145A). However, one or more of the DSL modems 145A and 145B and/or the noise cancellers 147A and 147B need not be implemented at and/or within their respective NID 148A, 148B. For example, the noise cancellers 147A and 147B could be implemented within the NIDs 148A and 148B, and the DSL modems 145A and 145B implemented elsewhere within the customer-premises 110A and 110B. Alternatively one or more of the DSL modems 145A and 145B and/or the noise cancellers 147A and 147B may be partially implemented within a NID 148A, 148B. For example, a device (e.g., a filter, all or any portion of an analog front-end, etc.) may be installed and/or implemented within a NID 148A, 148B to provide a matched termination impedance to a corresponding sensing wire-pair 160A, 160B, and to isolate the effects of customer-premises wiring from the sensing wire-pair 155 and/or other sensing wire-pairs 160A and 160B. The remaining portion(s) of the noise canceller 147A, 147B and/or the DSL modem 145A, 145B could be communicatively coupled to the device within the NID and located elsewhere within the customer-premises 110A, 110B (e.g., in a modem housing located nearby a personal computer). Thus, for example, the example noise canceller 202 of the example receiver 200 of FIG. 2 may be implemented by and/or within the NID while the example DSL receiver module 240 of FIG. 2 is implemented by a conventional DSL modem located within the customer premises. For example, an output 235 of the noise processor 230 may be converted back into an analog DSL signal for transmission and subsequent processing by the conventional DSL modem. In another example, the output 235 of the noise canceller 202 is provided as a digital signal to the DSL receiver module 240 which is implemented elsewhere within the customer premises (e.g., not within the NID).

To allow the example noise cancellers 147A and 148B to cancel noise present on and/or coupled into their respective active wire-pairs 142A and 142B, the example noise cancellers 147A and 148B are connected to a common reference (i.e., sensing) wire-pair 155 of the distribution cable 130. For example, the noise canceller 147A of FIG. 1 is connected to the sensing wire-pair 155 via a wire-pair 160A of the drop cable 140A. Likewise, the example noise canceller 147B is connected to the sensing wire-pair 155 via a wire-pair 160B of its drop cable 140B. In the illustrated example of FIG. 1, the sensing wire-pairs 160A and 160B are electrically coupled (e.g. spliced) to the common wire pair 155 at the example serving terminal 135. While throughout the following discussion reference will be made to the example sensing wire-pairs 160A and 160B, persons of ordinary skill in the art will readily appreciate that signals present on the sensing wire-pairs 160A and 160B are, at least partially, influenced and/or determined by signals on and/or introduced into the sensing wire-pair 155 of the distribution cable 130 to which the sensing wire-pairs 160A and 160B are electrically coupled.

Because, the active wire-pairs 142A and 142B and the sensing wire-pairs 155, 160A and 160B are contained (at least partially) within the same distribution cable 130 and/or shared drop cables 140A and 140B, they experience substantially the same environmental noise (e.g., radio frequency (RF) interference) and/or crosstalk noise (e.g., from other DSL modems, such as the DSL modems 145A and 145B, that share the same distribution cable 130). The example noise cancellers 147A and 148B receive noise signals on their respective sensing wire-pairs 160A and 160B, and use the received noise signals to cancel (e.g., remove and/or mitigate) noise present on their respective active wire-pairs 142A and 142B. For example, the noise canceller 147A can characterize, measure, estimate and/or parameterize a relationship between noise present on its sensing wire-pair 160A with noise present on its active wire-pair 142A. The relationship between the noise on these wire-pairs 142A, 160A can then be used to cancel noise present on the corresponding active wire-pair 142A. For instance, one or more filter coefficients that represent correlation(s) between these noises can be estimated. The filter coefficients can then be applied to signals received on the sensing wire-pair 160A, and outputs of the filter subtracted from signals (e.g., DSL signals containing noise) received on the active wire-pair 142A to substantially remove the noise from the active DSL signals. The example noise canceller 147B can likewise cancel noise present on its active wire-pair 142B using signals measured on its sensing wire-pair 160B.

In the illustrated example of FIG. 1, the sensing wire-pair 155 is not used to carry and/or transport a DSL communication signal (i.e., it is not used to provide a DSL communication service). However, in other examples, it may carry DSL communication signals and/or other types of signals. Moreover, as illustrated in FIG. 1, the sensing wire-pair 155 may be connected via, for example, the SAI 125 and the F1 cable 120 to the CO 105 and/or, more specifically, to the DSLAM 115. As a result, the DSLAM 115 may transmit one or more signals useful to the noise cancellers 147A and 147B and/or the DSL modems 145A and 145B while determining the correlation(s) between signals received on the sensing wire-pairs 160A and 160B and their respective active wire-pairs 142A and 142B. However, the sensing wire-pair 155 need not be connected at the SAI 125 to the F1 cable 120, and/or at the CO 105 to the DSLAM 115 or and/or other equipment.

To reduce the effects of coupling the sensing wire-pair 155 to more than one sensing wire-pair 160A and 160B (i.e., the presence of multiple bridged taps on the sensing wire-pair 155), the example noise cancellers 147A and 148B of FIG. 1 provide, include and/or implement a matched termination impedance (not shown) for their respective wire-pair 160A, 160B. The matched termination impedances are selected to reduce reflections of signals present on the wire-pairs 160A and 160B at the modems 145A and 145B.

FIG. 2 illustrates an example manner of implementing a receiver 200 for any or all of the example DSL modems 110A and 110B of FIG. 1 that includes and/or incorporates a noise canceller (e.g., one of the example noise cancellers 147A and 147B of FIG. 1). While the example receiver 200 of FIG. 2 may be used in any of the example DSL modems 110A and 110B of FIG. 1, for ease of discussion, the following description will be made with respect to the DSL modem 110A. Moreover, any or all of the example noise cancellers 147A and 148B may be implemented by the example noise canceller 202 of FIG. 2. Further, while the example receiver 200 of FIG. 2 includes and/or implements the noise canceller 202, any or all of an example noise canceller 202 may be implemented separately from the remainder of the receiver 200 and/or a DSL modem 110A, 110B.

In the illustrated example of FIGS. 1 and/or 2, the active wire-pair 142A may simultaneously carry both POTS signals (i.e., telephone service signals), and DSL signals transmitted and/or received by the DSL modem that includes and/or implements the example receiver 200. For example, asymmetric DSL (ADSL) signals are typically transmitted above 20 kHz (20 thousand cycles per second) and, thus, do not interfere with POTS signals (which are typically transmitted below 3 kHz). To keep transients associated with POTS (e.g., ring voltages, ring trip transients, etc.) and DSL signals from interfering, the example receiver 200 of FIG. 2 include any type of splitter 205. Using any number and/or type(s) of circuit(s), components and/or topologies, the example splitter 205 of FIG. 2 separates POTS signals and DSL signals. In the example of FIG. 2, POTS signals received on the active wire-pair 142A are segregated by the splitter 205 onto a telephone line 210, and DSL signals received on the active wire-pair 142A are provided to an analog module 215. The example telephone line 210 of FIG. 2 may be connected via any number, type(s) and/or topology(-ies) of telephone wires to any number and/or type(s) of telephone jacks and/or telephones (not shown) within a customer-premises.

Using any number and/or type(s) of circuit(s), components and/or topologies, the example analog module 215 of FIG. 2 converts analog DSL signals received from the example splitter 205 into a digital form (e.g., a stream of digital samples) suitable for processing by remaining portions of the example receiver 200. An example analog module 215 includes one or more filters, one or more programmable gain amplifiers and any type of analog-to-digital converter.

To properly terminate the sensing wire-pair 160A, the example noise canceller 202 of FIG. 2 includes a matched impedance 220. The example matched impedance 220 of FIG. 2 is designed and/or implemented to have impedance characteristics that substantially match the impedance characteristics of the sensing wire-pair 160A to reduce the reflection of signals present on the sensing wire-pair 160A. In some examples, the matched impedance 220 may have a design substantially fixed during manufacturing. In other examples, the impedance characteristics of the matched impedance 220 may be adaptively adjusted and/or tuned by a technician, and/or by other parts of the noise canceller 202 and/or the receiver 200 (e.g., a digital signal processor (DSP) implemented elsewhere within the noise canceller 202 and/or the receiver 200).

To convert analog signals received on the sensing wire-pair 160A into a digital form (e.g., a stream of digital samples) suitable for processing by remaining portions of the example noise canceller 202, the example noise canceller 202 of FIG. 2 includes another analog module 225. The example analog module 225 of FIG. 2 is substantially similar to the example analog module 215, and includes one or more filters, one or more programmable gain amplifiers and any type of analog-to-digital converter.

As described above, because the active wire-pairs 142A and the sensing wire-pair 160A are contained (at least partially) within the same distribution cable 130 and/or shared drop cables 140A, they experience substantially the same environmental noise (e.g., radio frequency (RF) interference) and/or crosstalk noise (e.g., from other DSL modems that share the same distribution cable 130). To cancel noise present in and/or contained within DSL signals received on the active wire-pair 142A based on signals received on the sensing wire-pair 160A, the example noise canceller 202 of FIG. 2 includes the noise processor 230. The example noise processor 230 of FIG. 2 characterizes, measures, estimates and/or parameterizes one or more relationships between noise present on the sensing wire-pair 160A and noise present on the active wire-pair 142A. Such characterization of the sensing wire-pair noise and the active wire-pair noise may occur during, for example, a quiet line noise (QLN) training intervals of DSL modem initialization when neither the DSLAM 115 nor the DSL modem that includes and/or implements the example noise canceller 202 are transmitting on the active wire-pair 142A. During such QLN training intervals, signals received on the active wire-pair 142A substantially represent the noise present on the active wire-pair 142A.

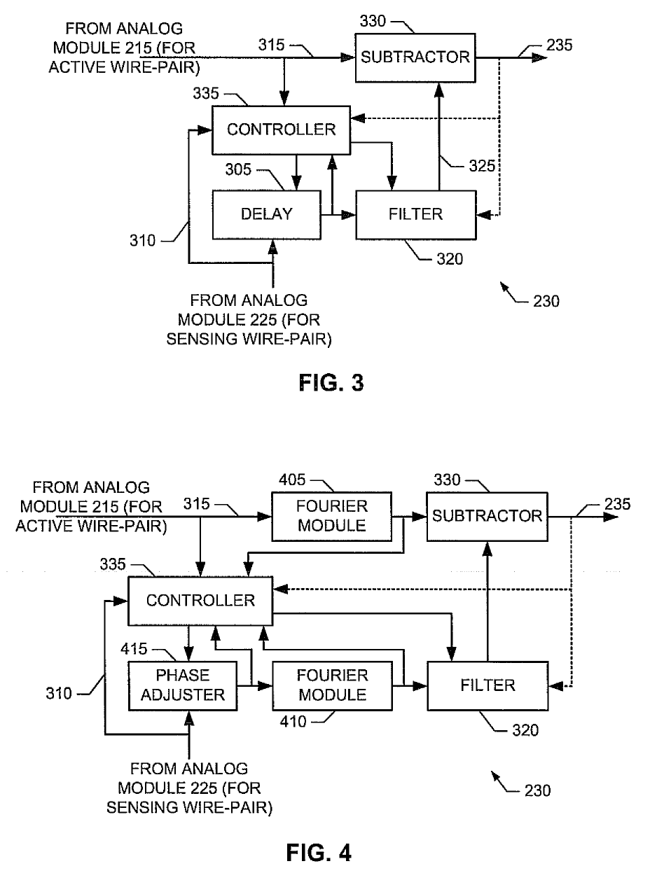

As described more fully below in connection with FIGS. 3 and 4, the example noise processor 230 of FIG. 2 uses the relationship(s) between the noises on the two paths 142A and 160A to cancel noise present on the active wire-pair 142A. For example, the noise processor 230 can compute one or more filter coefficients that represent correlation(s) between the noise present on the active wire-pair 142A and noise present on the sensing wire-pair 160A. The noise processor 230 can then apply the filter coefficients to signals received on the sensing wire-pair 160A, and subtract the outputs of the filter from signals (e.g., DSL signals containing noise) received on the active wire-pair 142A to form enhanced DSL signals 235 (i.e., a DSL signal with a substantially amount of environmental and/or crosstalk noise removed). Example manners of implementing the example noise processor 230 of FIG. 2 are described below in connection with FIGS. 3 and 4.

To extract user data and/or control data from the enhanced DSL signals 235, the example receiver 200 of FIG. 2 includes a DSL receiver module 240. The example DSL receiver module 240 of FIG. 2 includes remaining portions of the example receiver 200 such as, for example, a modem initializer, an equalizer, a constellation decoder, an error correction decoder, and/or a de-framer.

While example manners of implementing a receiver 200 for any or all of the example DSL modems 110A and 110B of FIG. 1, and/or any or all of the example noise cancellers 147A and 147B have been illustrated in FIG. 2, one or more the elements, processes and devices illustrated in FIG. 2 may be combined, divided, re-arranged, omitted, eliminated and/or implemented in any of a variety of ways. Further, the example noise canceller 202, the example splitter 205, the example matched impedance 220, the example analog modules 215 and 220, the example noise processor 230, the example DSL receiver module 240 and/or, more generally, the example receiver 200 may be implemented by hardware, software, firmware and/or any combination of hardware, software and/or firmware. Further still, the example receiver 200 may include one or more elements, processes and/or devices in addition to, or instead of, those illustrated in FIG. 2, and/or may include more than one of any or all of the illustrated elements, processes and devices.

FIG. 3 illustrates an example manner of implementing the example noise processor 230 of FIG. 2. Because signals on a sensing wire-pair (e.g., the example sensing wire-pair 160A) may be received later in time than signals on an active wire-pair (e.g., the example active wire-pair 142A), the example noise processor 230 of FIG. 3 includes a delay 305. Using any number and/or type(s) of algorithm(s), block(s), method(s) and/or logic, the example delay 305 delays signals received on the sensing wire-pair (i.e., sensing wire-pair signals 310). An example delay 305 is implemented as a tapped delay line. Another example delay 305 is implemented using one or more filters (e.g., sub-band filters), that apply different amounts of delay to different frequencies and/or frequency ranges to accommodate group delay distortion differences between sensing wire-pair signals 310 and signals received on the active wire-pair (i.e., active wire-pair signals 315). However, any type and/or topology of delay 305 may be implemented.

To filter the delayed sensing wire-pair signals, the example noise processor 230 of FIG. 3 includes a filter 320. The example filter 320 applies one or more filter coefficients to the delayed sensing wire-pair signals (i.e., filters the delayed sensing wire-pair signals) so that outputs 325 of the filter 320 substantially (or at least partially) match noise contained within the active wire-pair signals 315.

To cancel noise contained within the active wire-pair signals 315, the example noise processor 230 of FIG. 3 includes a subtractor 330. The example subtractor 330 of FIG. 3 subtracts outputs 325 of the example filter 320 from the active wire-pair signals 315. Because the delay(s) implemented by the example delay 305 and the filter coefficients utilized by the example filter 320 are determined based on one or more relationships (e.g., correlation(s)) between the noise currently and/or historically received on the sensing wire-pair signals 310 and the noise currently and/or historically received on the active wire-pair signals 315, the filter outputs 325 correspond substantially with the noise present in the active wire-pair signals 315. That is, the delay 305 and the filter 320 transform the sensing wire-pair signals 310 so that the filter outputs 325 are highly correlated with the noise present in the active wire-pair signals 315 and, thus, can be subtracted from the active wire-pair signals 315 by the subtractor 330 to cancel the noise present in the active wire-pair signals 315.

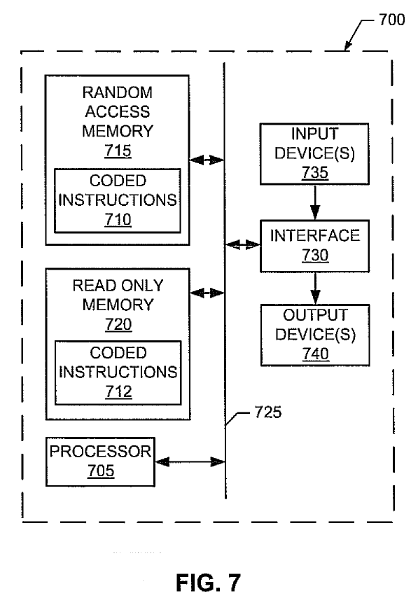

To direct the various operations of the example noise processor 230 of FIG. 3, the noise processor 230 includes any type of controller 335 (e.g., the example processor 705 discussed below in connection with FIG. 7). The example controller 335 of FIG. 3 determines the delay(s) to be performed by the example delay 305, the filter coefficient(s) to be applied by the example filter 320 and/or, more generally, controls the overall operation of the example noise processor 230 of FIG. 3. The example controller 335 may be one or more of any of any type of processors such as, for example, a microprocessor, a microcontroller, a processor core, a digital signal processor (DSP), a DSP core, an advanced reduced instruction set computing (RISC) machine (ARM) processor, etc. The example controller 335 executes coded instructions (e.g., any or all of the example coded instructions 710 and/or 712 of FIG. 7) which may be present in a memory of the controller 335 (e.g., within a random-access memory (RAM) and/or a read-only memory (ROM)) and/or within an on-board memory of the controller 335. For example, the example coded instructions may be executed to measure, compute and/or estimate one or more relationships (e.g., correlation(s)) between noise currently and/or historically received on the active wire-pair signals 315 and noise currently and/or historically received on the sensing wire-pairs 310, and to use the relationship(s) to set and/or adjust the delay(s) implemented by the example delay 305 and the filter coefficient(s) applied by the example filter 320. For example, the coded instructions may measure a time of arrival difference between impulse noise events to adjust the delay(s) implemented by the example delay 305, and may use least mean squares (LMS) adaptation to determine filter coefficient(s) that minimize the difference(s) between output(s) 325 of the filter 320 and noise received within the active wire-pair signals 315 (i.e., minimize the power of the noise present in the enhanced DSL signal 235). Additionally or alternatively, the coded instructions may be executed to implement any of the delay 305, the example filter 320, the example subtractor 330 and/or, more generally, the noise processor 230.

As illustrated in FIG. 3, the example controller 335 may respond to, and/or the example filter 320 may be adaptively adjusted based on, for example, outputs 235 of the example subtractor 330 (i.e., the enhanced DSL signal 235). For example, the controller 335 and/or the filter 320 may implement least-mean squares (LMS) updates to periodically or aperiodically adjust the filter coefficients being applied by the filter 320 to minimize the power of the noise currently present in the enhanced DSL signal 235. Such updates can be advantageous when the relationship(s) between active wire-pair noise and sensing wire-pair noise may change over time due to, for example, temperature changes, water in a drop cable 140A or 140B, etc. The update of the delay(s) implemented by the delay 305 and/or the filter coefficients applied by the filter 320 may, additionally or alternatively, be updated by the controller 335 based on, for example, the noise remaining in the enhanced DSL signal 235. Additionally or alternatively, the example controller 335 could monitor the relationship(s) between the active wire-pair noise and the sensing wire-pair noise directly based on the wire-pair signals 310 and 315.

FIG. 4 illustrates another example manner of implementing the example noise processor 230 of FIG. 2. Because elements of the example noise processor 230 of FIG. 4 are substantially similar, analogous and/or identical to those discussed above in connection with FIG. 3, the description of the like elements are not repeated here. Instead, similar and/or analogous elements are illustrated with identical reference numerals in FIGS. 3 and 4, and the interested reader is referred back to the descriptions presented above in connection with FIG. 3 for a complete description of those like numbered elements. Differences in analogous structures are discussed below.

Compared to the example noise processor 230 of FIG. 3, the example noise processor 230 of FIG. 4 performs noise cancellation in the frequency domain rather than the time domain. Frequency domain signals and/or frequency domain processing are often utilized in DSL modems (e.g., DSL modems implemented in accordance with the ITU G.992.x family of standards and/or the ITU G.993.x family of standards) and, thus, the example noise processor 230 of FIG. 4 may represent a more efficient implementation than the example noise processor 230 of FIG. 3.

To transform the active wire-pair signals 315 to the frequency domain, the example noise processor 230 of FIG. 4 includes any type of Fourier module 405. The example Fourier module 405 of FIG. 4 performs a fast Fourier transform (FFT) of a block of samples of the active wire-pair signals 315. Likewise, to transform the sensing wire-pair signals 310 to the frequency domain, the example noise processor 230 of FIG. 4 includes any type of Fourier module 410. The example Fourier module 410 of FIG. 4 performs a fast Fourier transform (FFT) of a block of samples of the sensing wire-pair signals 310. While two Fourier modules 405 and 410 are illustrated in FIG. 4, persons of ordinary skill in the art will readily appreciate that the Fourier modules 405 and 410 may be implemented using a single Fourier module. Moreover, when the example noise processor 230 of FIG. 4 is implemented with a DSL modem using frequency domain processing, the functionality of the Fourier modules 405 and 410 may be implemented separately from the noise processor 230 even though outputs of the Fourier modules 405 and 410 are utilized by the noise processor 230.

The example filter 320 and subtractor 330 of FIG. 4 operate on frequency domain signals. That is, they filter and/or perform subtractions at one or more of the frequencies represented by the outputs of the Fourier modules 405 and 410.

Because the sensing wire-pair signals 310 may be received earlier than the active wire-pair signals 315, the example noise processor 230 of FIG. 4 includes a phase adjuster 415. Using any number and/or type(s) of algorithm(s), block(s), method(s) and/or logic, the example phase adjuster 415 of FIG. 4 delays the sensing wire-pair signals 310. An example phase adjuster 415 is implemented as a tapped delay line. Another example phase adjuster 415 is implemented using one or more filters (e.g., sub-band filters) that apply different amounts of delay to different frequencies and/or frequency ranges to accommodate group delay distortion differences between sensing wire-pair signals 310 and the active wire-pair signals 315. Yet another phase adjuster 415 is implemented in the frequency domain by applying a Fourier transform, applying one or more per frequency equalizer coefficients to respective outputs of the Fourier transform, and inverse Fourier transforming the outputs of the per frequency equalizers. Still another phase adjuster 415 is implemented together with and/or by the example filter 320 and, thus, is applied to the outputs of the example Fourier module 410. However, any type and/or topology of phase adjuster 415 may be implemented.

While example manners of implementing the example noise processor 230 of FIG. 2 have been illustrated in FIGS. 3 and 4, one or more of the elements, processes and/or devices illustrated in FIGS. 3 and/or 4 may be combined, divided, re-arranged, omitted, eliminated and/or implemented in any other way. Further, the example delay 305, the example filter 320, the example substractor 330, the example controller 335, the example Fourier modules 405 and 410, the example phase adjuster 415 and/or, more generally, the example noise processor 230 may be implemented by hardware, software, firmware and/or any combination of hardware, software and/or firmware. Further still, the example noise processor 230 may include one or more elements, processes and/or devices in addition to, or instead of, those illustrated in FIGS. 3 and/or 4, and/or may include more than one of any or all of the illustrated elements, processes and devices.

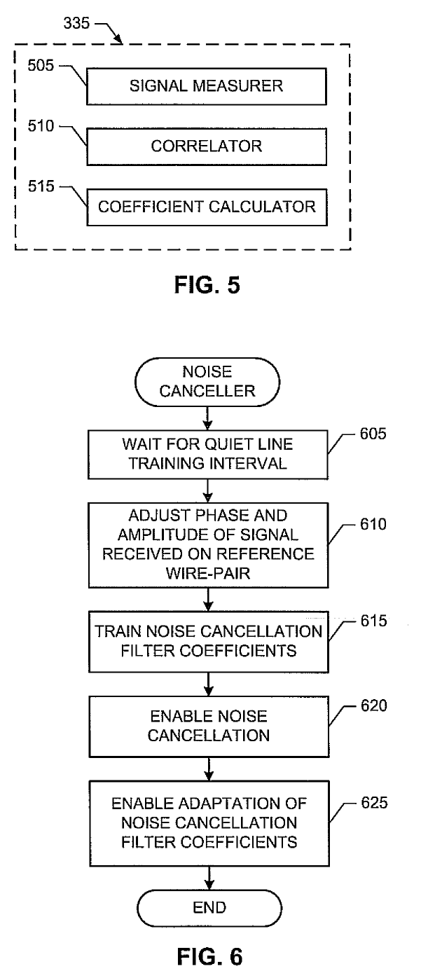

FIG. 5 illustrates an example manner of implementing any or all of the example controllers 335 of FIGS. 3 and 4. To measure signals, the example controller 335 of FIG. 5 includes a signal measurer 505. The example signal measurer 505 of FIG. 5 captures and/or measures active wire-pair signals and/or sensing wire-pair signals for use in adjusting and/or controlling the operating of the noise processor 230 that implements and/or includes the controller 335. The example signal measurer 505 measures active wire-pair signals and/or sensing wire-pair signals during, for example, a QLN training interval. The signal measurer 505 may include one or more buffers and/or inputs to capture and/or store received signals (e.g., wire-pair signals 310 and 315)

To determine one or more relationships between noise of an active wire-pair signal and noise of a sensing wire-pair signal, the example controller 335 of FIG. 5 includes a correlator 510. Using any number and/or type(s) of algorithm(s), method(s) and/or logic, the example correlator 510 of FIG. 5 correlates active wire-pair signals and sensing wire-pair signals measured by the signal measurer 505. For example, for a frequency domain implementation, the correlator 510 can determine a correlation Xₙ for the n^{th} frequency for a set of Fourier transform intervals using the following mathematical expression:

$${X}_{n} = \frac{1}{L} {\sum }_{l = 1}^{L} \frac{{E}_{n} ( l )}{{T}_{n} ( l )} , \qquad EQN ( 1 )$$

where l is used to index Fourier transform intervals, Tₙ(l) are the outputs of the Fourier transform of the active wire-pair signal 315 for the l^{th} interval, Eₙ(l) are differences of Fourier transform outputs of the active wire-pair signal 315 and Fourier transform outputs of the sensing wire-pair signal 310 for the l^{th} interval, and L is the number of Fourier transform intervals. Frequencies n for which Xₙ is large represent frequencies for which a large correlation exists between active wire-pair noise and sensing wire-pair noise. The mathematical expression of EQN (1) may be used to periodically or aperiodically update the correlation values Xₙ by utilizing a sliding window of Fourier transform intervals whereby data for more recent intervals are considered and data from older intervals is discarded. While not show in EQN(1), differing weights (e.g., selected exponentially) may be applied to the different Fourier transform intervals so that more recent intervals have a larger impact on the correlation values Xₙ.

To determine filter coefficients, the example controller 335 of FIG. 5 includes a coefficient calculator 515. Using any number and/or type(s) of algorithm(s), method(s) and/or logic, the example coefficient calculator 515 of FIG. 5 computes one or more filter coefficients based on relationships (e.g., the Xₙ correlations) computed by the example correlator 510. For example, the coefficient calculator 515 may compare the magnitude of each correlation Xₙ with a threshold, and when a correlation Xₙ exceeds the threshold compute a corresponding frequency domain filter coefficient for the corresponding frequency as 1/Xₙ*, where * represents the complex conjugate operator.

Using any number and/or type(s) of algorithm(s), method(s) and/or logic, the example coefficient calculator 515 also determines the delay(s) to be applied to the sensing wire-pair signals. For example, the coefficient calculator 515 directs the example correlator 510 to perform a series of time-domain correlations of sensing wire-pair signals and active wire-pair signals for different delays of the sensing wire-pair signals. Historical and/or current wire-pair signals may be used to perform the time-domain correlations. The coefficient calculator 515 then selects the delay corresponding to the largest correlation as the delay to be applied. Additionally or alternatively, the example coefficient calculator 515 compares time domain waveforms for the occurrence of rising and/or falling edges of noise characteristic of, for example, impulse noise.

While example manner of implementing any or all of the example controllers 335 of FIGS. 3 and 4 have been illustrated in FIG. 5, one or more the elements, processes and devices illustrated in FIG. 5 may be combined, divided, re-arranged, omitted, eliminated and/or implemented in any other way. Further, the example signal measurer 505, the example correlator 510, the example coefficient calculator 515 and/or, more generally, the example controller 335 may be implemented by hardware, software, firmware and/or any combination of hardware, software and/or firmware. Further still, the example controller 335 may include one or more elements, processes and/or devices in addition to, or instead of, those illustrated in FIG. 5, and/or may include more than one of any or all of the illustrated elements, processes and devices.

FIG. 6 is a flowchart representative of example machine accessible instructions which may be carried out to implement any or all of the example noise cancellers 147A, 147B and 202 of FIGS. 1 and 2. The example machine accessible instructions of FIG. 6 may be carried out by a processor, a controller and/or any other suitable processing device. For example, the example machine accessible instructions of FIG. 6 may be embodied in coded instructions stored on a tangible medium such as a flash memory, a ROM and/or RAM associated with a processor (e.g., the example processor 705 discussed below in connection with FIG. 7). Alternatively, some or all of the example machine accessible instructions of FIG. 6 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example machine accessible instructions of FIG. 6 may be implemented manually or as any combination of any of the foregoing techniques, for example, any combination of firmware, software, discrete logic and/or hardware. Further, although the example machine accessible instructions of FIG. 6 are described with reference to the flowchart of FIG. 6, persons of ordinary skill in the art will readily appreciate that many other methods of implementing the machine accessible instructions of FIG. 6 may be employed. For example, the order of execution of the blocks may be changed, and/or one or more of the blocks described may be changed, eliminated, sub-divided, or combined. Additionally, persons of ordinary skill in the art will appreciate that any or all of the example machine accessible instructions of FIG. 6 may be carried out sequentially and/or carried out in parallel by, for example, separate processing threads, processors, devices, discrete logic, circuits, etc.

The example machine accessible instructions of FIG. 6 begin with a noise canceller (e.g., any of the example noise processors 230 of FIGS. 2, 3 and/or 4) waiting for a quiet line training interval (block 605). When the quiet line training interval begins, the noise processor (e.g. the example signal measurer 505 of FIG. 5 and/or, more generally, the example controller 335 of FIG. 3) collects noise samples, and the noise canceller (e.g., the example correlator 510 of FIG. 5 and/or, more generally, the example controller 335) determines the delay and/or phase adjusts to be applied to sensing wire-pair signals to maximize their correlation with active wire-pair signals (block 610).

The noise processor (e.g., the example coefficient calculator 515 of FIG. 5 and/or, more generally, the example controller 335 and/or the example filter 320 of FIG. 3) then computes filter coefficients to be applied to the sensing wire-pair signals (block 615) by, for example, correlating the sensing and active wire-pair signals and using correlation outputs to compute the filter coefficients. The noise processor (e.g., the example controller 335) enables noise cancellation to reduce the noise present in the active wire-pair signals (block 620), and enables the periodic or aperiodic adjustment and/or update of the filter coefficients and/or the delay(s) (block 625). Such adjustments and/or updates of the filter coefficients and/or delay(s) may be performed, for example, by the example controller 335 and/or the filter 320 using LMS updates performed using recently and/or currently received wire-pair signals (e.g., the example wire-pair signals 310 and 315) while active DSL signals are being received (e.g., not during a quiet line training interval). Control then exits from the example machine accessible instructions of FIG. 6.

FIG. 7 is a schematic diagram of an example processor platform 700 that may be used and/or programmed to implement any portion(s) and/or all of the example noise cancellers 147A and 147B, the example noise cancellers 230, and/or the example DSL modems 145A and 145B of FIGS. 1-5. For example, the processor platform 700 can be implemented by one or more processors, processor cores, microcontrollers, DSPs, DSP cores, ARM processors, ARM cores, etc.

The processor platform 700 of the example of FIG. 7 includes at least one programmable processor 705. The processor 705 executes coded instructions 710 and/or 712 present in main memory of the processor 705 (e.g., within a RAM 715 and/or a ROM 720). The processor 705 may be any type of processing unit, such as a processor core, a processor and/or a microcontroller. The processor 705 may execute, among other things, the example machine accessible instructions of FIG. 6 to implement any or all of the example noise cancellers 147A and 147B, the example noise processor 230, and/or, more generally, the example DSL modems 145A and 145B described herein. The processor 705 is in communication with the main memory (including a ROM 720 and/or the RAM 715) via a bus 725. The RAM 715 may be implemented by DRAM, SDRAM, and/or any other type of RAM device, and ROM may be implemented by flash memory and/or any other desired type of memory device. Access to the memory 715 and 720 may be controlled by a memory controller (not shown). The RAM 715 may be used to store and/or implement, for example, filter coefficients for the example filters 320 of FIGS. 3 and/or 4.

The processor platform 700 also includes an interface circuit 730. The interface circuit 730 may be implemented by any type of interface standard, such as a USB interface, a Bluetooth interface, an external memory interface, serial port, general purpose input/output, etc. One or more input devices 735 and one or more output devices 740 are connected to the interface circuit 730. The input devices 735 and/or output devices 740 may be used to receive, capture and/or measure the active wire-pair signals 315 and/or the sensing wire-pair signals 310.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. For instance, DSL, POTS, VoIP, IP, Ethernet over Copper, fiber optic links, DSPs, the ITU-T G.993.x family of standards and/or the ITU-T G.992.x family of standards represent examples of the current state of the art. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
measuring a first signal present on a first wire-pair at a noise canceller, the first wire-pair to be connected to the first noise canceller and to be connected to a customer-premises digital subscriber line (DSL) modem, wherein the noise canceller and the customer-premises DSL modem are to be disposed at different customer-premises locations; and
cancelling a first noise received on a second wire-pair at the noise canceller based on the first signal.

2. A method as defined in claim 1, wherein the first wire-pair is not used to provide a DSL communication service, and wherein the first and second wire-pairs are located within a same distribution cable.

3. A method as defined in claim 1, further comprising receiving a second signal on the second wire-pair that includes the first noise and a DSL communication signal.

4. A method as defined in claim 1, further comprising:
determining a filter coefficient based on the first signal; and
applying the filter coefficient to cancel the first noise received on the second wire-pair.

5. A method as defined in claim 4, wherein determining the filter coefficient based on the first signal comprises:
measuring a second noise present on the second wire-pair; and
determining a correlation between the first signal and the second noise, wherein the filter coefficient is selected to represent the correlation.

6. A method as defined in claim 4, wherein applying the filter coefficient to cancel the first noise received on the second wire-pair comprises:
computing a filter output by applying the filter coefficient to a second signal received on the first wire-pair;
receiving a third signal on the second wire-pair, the third signal including the first noise; and
computing a difference of the third signal and the filter output.

7. A method as defined in claim 6, further comprising delaying the second signal before the coefficient is applied.

8. A method as defined in claim 1, wherein the customer-premises DSL modem includes a second noise canceller, the second noise canceller to use a second signal measured on the first wire-pair at the customer-premises DSL modem to cancel second noise, the second noise received at the second customer-premises DSL modem on a third wire-pair.

9. A method as defined in claim 1, wherein the noise canceller is implemented in a network interface device.

10. A method as defined in claim 1, wherein the noise canceller is implemented in a second customer-premises DSL modem.

11. A method as defined in claim 1, wherein the different customer-premises locations are different apartments of an apartment building.

12. An article of manufacture storing machine accessible instructions which, when executed, cause a machine to:
measure a first signal present on a first wire-pair at a noise canceller, the first wire-pair to be connected to the first noise canceller and to be connected to a customer-premises digital subscriber line (DSL) modem, wherein the noise canceller and the customer-premises DSL modem are to be disposed at different customer-premises locations; and
cancel a first noise received on a second wire-pair at the noise canceller based on the first signal.

13. An article of manufacture as defined in claim 12, wherein the first wire-pair is not used to provide a DSL communication service, and wherein the first and second wire-pairs are located within a same distribution cable.

14. An article of manufacture as defined in claim 12, wherein the machine accessible instructions, when executed, cause the machine to receive a second signal on the second wire-pair that includes the first noise and a DSL communication signal.

15. An article of manufacture as defined in claim 12, wherein the machine accessible instructions, when executed, cause the machine to:
determine a filter coefficient based on the first signal; and
apply the filter coefficient to cancel the first noise received on the second wire-pair.

16. An article of manufacture as defined in claim 15, wherein the machine accessible instructions, when executed, cause the machine to determine the filter coefficient based on the first signal by:
measuring a second noise present on the second wire-pair; and
determining a correlation between the first signal and the second noise, wherein the filter coefficient is selected to represent the correlation.

17. An article of manufacture as defined in claim 15, wherein the machine accessible instructions, when executed, cause the machine to apply the filter coefficient to cancel the first noise received on the second wire-pair by:
computing a filter output by applying the filter coefficient to a second signal received on the first wire-pair;
receiving a third signal on the second wire-pair, the third signal including the first noise; and
computing a difference of the third signal and the filter output.

18. An article of manufacture as defined in claim 17, wherein the machine accessible instructions, when executed, cause the machine to delay the second signal before the coefficient is applied.

19. A noise canceller to cancel a first noise received on a first wire-pair based on a first signal received on a second wire-pair, the second wire-pair to be in communication with a first customer-premises digital subscriber line (DSL) modem and to be in communication with a second customer-premises DSL modem, the first customer-premises DSL modem to be disposed at a first customer-premises location, and the second customer-premises DSL modem to be disposed at a second customer-premises location, the noise canceller comprising:
a filter to apply a filter coefficient to the first signal; and
a subtractor to subtract an output of the filter from the first noise.

20. A noise canceller as defined in claim 19, further comprising:
a signal measurer to measure a second noise present on the second wire-pair;
a correlator to determine a correlation of a second signal measured on the first wire-pair and the second noise; and
a coefficient calculator to calculate the filter coefficient based on the correlation.

21. A noise canceller as defined in claim 19, further comprising a delay to delay the first signal before the filter coefficient is applied.

22. A noise canceller as defined in claim 19, further comprising an analog module to receive a second signal on the first wire-pair that includes the first noise and a DSL communication signal.

23. A noise canceller as defined in claim 19, wherein the noise canceller is located in a network interface device.

24. A noise canceller as defined in claim 19, wherein the noise canceller is located in a DSL access multiplexer.

25. A noise canceller as defined in claim 19, wherein the noise canceller is located in first customer-premises DSL modem.

26. A noise canceller as defined in claim 19, further comprising a matched impedance termination to impedance match the second wire-pair.

27-49. (canceled)
